(19) United States
(12) Patent Application Publication
(10) Pub. No.: US 2026/0025862 A1
(43) Pub. Date: Jan. 22, 2026

(54) METHOD FOR CONNECTING A VEHICLE TO THE INTERNET

(71) Applicant: MERCEDES-BENZ GROUP AG, Stuttgart (DE)

(72) Inventors: Baris BALOGLU, Stuttgart (DE); Simon BIEHL, Düsseldorf (DE); Jing ZHOU, Pliezhausen (DE); Dmitar ABADZIC, Fellbach (DE); Frank MEISTER, Böblingen (DE); Xin GUO, Stuttgart (DE)

(21) Appl. No.: 18/993,067

(22) PCT Filed: Jul. 3, 2023
(86) PCT No.: PCT/EP2023/068259

§ 371 Date: Jan. 10, 2025

(30) Foreign Application Priority Data
Jul. 13, 2022 (DE) 10 2022 002 561.2

(51) Int. Cl. H04W 76/10; G07C 5/00; H04W 4/44

(52) U.S. Cl. CPC H04W 76/10; G07C 5/008; H04W 4/44

(57) ABSTRACT

A vehicle includes a control system, which can maintain at least two access points, to connect to the Internet. A first access point is used for a service channel set up between the vehicle manufacturer and the Internet service provider. A second access point is provided for a further channel. Before the use of the further channel, the control system collects user-related data known to it or accessible for the control system on servers, external to the vehicle, of the vehicle manufacturer connected via the service channel. After which, the parameters required for establishing an Internet connection via the further channel are extracted from the data. The control system is set up to enable this transmission via the first access point.

### BACKGROUND AND SUMMARY OF THE INVENTION

Exemplary embodiments of the invention relate to a method for connecting a vehicle to the Internet.

An internet connection between a vehicle and a server external to the vehicle, for example a backend server of the vehicle manufacturer or OEM, is known from the prior art. In this context, reference can be made to DE 10 2016 106 610 A1 purely by way of example. This describes a communication system implementing a connection between the vehicle and the Internet via various access points or access point names (APN). On the one hand, it describes the use of an access point for a private channel, a type of service channel, which exchanges data between a telematics unit of the vehicle and a server, external to the vehicle, of the vehicle manufacturer. This data can, for example, influence the driving properties of the vehicle, can outsource computing processes from the vehicle to the server, for example as part of surroundings recognition, image recognition of traffic signs, traffic situations or similar. Completely or partially outsourcing the functionality of a navigation system to the server external to the vehicle can also be implemented via such a service channel. Typical for this service channel, which is referred to as a private APN in the above-mentioned document, is that it is relatively well secured in order to prevent unauthorized access to the vehicle.

In practice, there are also no costs for the vehicle user via this service channel, since this service channel is based on a contractual agreement between the vehicle manufacturer and the Internet service provider, such that these Internet services are virtually “supplied” with the vehicle.

In addition, a second access point can be used, which is referred to as a public APN in the above-mentioned document. This can be used by the vehicle user, for example for streaming corresponding content such as videos, music or similar, for example. This type of use, which differs from the use of the service channel in terms of content, should typically not be carried out via the service channel.

The above-mentioned DE 10 2016 106 610 A1 substantially describes how this can be reinstalled in the event that one of the connections is lost.

In practice, however, it is much more important how such a connection can be established in the first place, for example when a user wants to establish a further Internet connection to the Internet service provider in parallel to the existing service channel of the vehicle manufacturer with the Internet service provider in order to be able to use further services from the vehicle for their private purposes. The vehicle manufacturer itself has an interest in ensuring that such a communication does not take place via its service channel, if only for security reasons.

Exemplary embodiments of the present invention are thus directed to an improved method for connecting a vehicle to the Internet, which can offer at least two access points for a service channel on the one hand and for a further channel on the other hand.

In the method according to the invention, the control system now collects user-related data known to it or accessible to the control system on the servers, external to the vehicle, of the vehicle manufacturer connected via the service channel before using the further channel. This allows, for example, data from other services or from service agreements with the vehicle manufacturer, e.g., IDs, bank details, etc., to be used. Subsequently, the parameters required to set up an Internet connection for the further channel or via the second access point are then extracted from the data and transmitted to the Internet service provider such that the latter has all the data required to set up and bill the additional channel. Since the further channel has not yet been set up at this point, the control system is set up to enable this transmission of the parameters via the first access point, i.e., the service channel.

The vehicle manufacturer therefore ultimately offers the vehicle user, i.e., its end customer, via the control system of the vehicle to set up the further channel in the vehicle via the service channel, which is otherwise blocked for such data, such that the further channel in the vehicle can be negotiated and set up with the Internet service provider via the second access point despite the fact that the Internet connection does not yet exist. Thus, a technological solution for a very user-friendly design of such processes is created.

Here, the two access points can be technically implemented in the vehicle via a single SIM, and thus via an Internet service provider, such that the vehicle user can easily and efficiently create the further channel in the vehicle without having to be active beforehand with regard to the Internet connection.

A very advantageous development of the invention here provides that the parameters comprise at least the user identification data to set up the second access point. The control system thus filters the data known to it in such a way that user identification data is available as the basis for the further channel via the second access point. This can comprise data in its own memory, i.e., also data to which the control system has access via the service channel, e.g., registration data of the same user with other services of the vehicle manufacturer or also data stored by the vehicle manufacturer for such purposes.

According to a very advantageous development of the method according to the invention, it can here be provided that the parameters comprise at least one technical variable for setting up the second access point. Such a technical variable can be, for example, a required amount of data via the further channel or a security level for the communication. According to such a variable, a parameter can then be transmitted for setup, which enables the corresponding amount of data or also specifies the required connection standard depending on the amount of data. In the case of a high security level, the parameter could, for example, comprise the setup directly as a VPN connection.

According to a very advantageous development of the method according to the invention, the control system can furthermore be set up to estimate the amount of data required in the further channel. According to a very favorable design of the invention, the preselected services, already installed applications or also past data of the user or other users can be analyzed for this purpose. In addition, such analyses can also be used for further technical variables and/or parameters. Here, boundary conditions, such as country-specific regulations etc., can additionally be taken into consideration.

According to a very advantageous development, the control system can moreover use the country of vehicle registration as a parameter, such that, for example, certain legal requirements in the country of vehicle registration can be correspondingly taken into consideration and the services of the Internet service provider for this country can be correspondingly selected or offered. The consideration of language specifications and/or legal requirements of the respective country can also be managed easily and efficiently via the control system in this way.

The method according to the invention is particularly efficient, since it automatically collects and compiles the necessary parameters. The user can then simply acknowledge this and thus quickly and efficiently initiate the setup of the second access point for the further channel. Preferably, this can be done via a single sign-on functionality, in which the vehicle user is already registered and authenticated in the vehicle system and can thus acknowledge the transmission of the parameters for setting up the further channel to the control system by simply pressing a button, a voice command or similar.

Should not all data be accessible to the control system for extracting the parameters required for the setup, then, according to a very advantageous development of the method according to the invention, a request for this additionally required data can be carried out with the vehicle user. This can preferably be carried out in the form of a pop-up menu, for example via a so-called head unit, with a central touchscreen of the vehicle, in order to thus be able to easily and efficiently add the required data in order to be able to transfer the required parameters from the vehicle of the vehicle user to the Internet service provider.

As already mentioned, it can be technically implemented in such a way that, to enable the transmission of the parameters via the first access point and thus the service channel, the access data to the Internet addresses required for setting up the further channel is explicitly permitted via an exception list for the service channel. Such an exception list, which is also referred to with the English term as a whitelist, would thus allow these parameters to be switched through via the service channel and could furthermore ensure that no other data transfers are carried out via the service channel.

According to a very favorable design of the invention, it can correspondingly be provided that the control system strictly separates the data transfer via the service channel and the data transfer via the further channel immediately after completion of the setup thereof, in order to implement a clear cost distribution on the one hand and to be able to guarantee the security of the service channel simply and efficiently on the other hand.

The control system itself can here be at least partially implemented on the server external to the vehicle, such that the service channel is integrated into the processing of the entire communication management being carried out by the control system. Alternatively, the control system can also be at least partially implemented in a computing unit of the vehicle. Preferably, this is a hybrid control system in which individual components are implemented inside the vehicle and other components are outsourced to the server external to the vehicle.

Further advantageous designs of the method according to the invention and the procedures enabled by the method also emerge from the exemplary embodiment, which is described in more detail below with reference to the figures.

### BRIEF DESCRIPTION OF THE DRAWING FIGURES

Here are shown:

FIG. 1 a schematic depiction of the relationship between vehicle, vehicle user and Internet service provider;

FIG. 2 a schematic depiction of the Internet connections between the vehicle, the server external to the vehicle and the entertainment facilities of the Internet;

FIG. 3 a possible system architecture for implementing the method according to the invention;

FIG. 4 a possible procedure of the method according to the invention; and

FIG. 5 a schematic depiction for illustrating a simplified authentication.

### DETAILED DESCRIPTION

In principle, in a new vehicle 2, an Internet connection of the vehicle 1 for entertainment purposes does not exist, i.e., for example streaming video and audio services, because the vehicle owner or vehicle user 1 does not yet have an independent contract with an Internet service provider ASP (Application Service Provider). The relationship between these three entities, i.e., the vehicle user 1 on the one hand, the vehicle 2 or its manufacturer OEM (Original Equipment Manufacturer), symbolized here by a box around the vehicle 2, on the other hand, and the Internet service provider ASP is illustrated schematically in the diagram in FIG. 1.

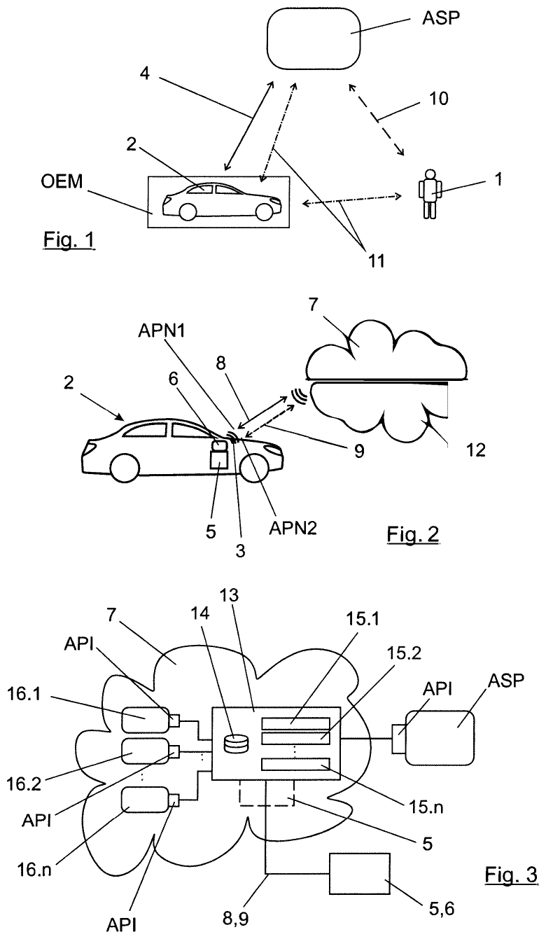

In the depiction in FIG. 1, the vehicle 2 symbolizes both the vehicle 2 as such and also the communication devices 3 and control systems 5—shown in FIG. 2—as well as the so-called head unit 6, i.e., the central display and control device of the vehicle 2 on the other hand. Typically, there is a general contractual agreement 4 between the manufacturer OEM of the vehicle 2 and the Internet service provider ASP, such that the vehicle 2 or its control system 5 can operate a service channel 8 between the vehicle 2 and a server 7 external to the vehicle, typically the so-called backend server of the vehicle manufacturer OEM, via a first access point APN1 (APN—Access Point Name) indicated in FIG. 2.

In the depiction of FIG. 2, the vehicle 2 can be seen with its control system 5 and its head unit 6, which could also be referred to as the front end. There is a connection at least to a backend server 7 of the vehicle manufacturer, which is indicated here as a cloud, via corresponding communication devices 3. Via the general contractual agreement 4 between the manufacturer OEM of the vehicle 2 and the Internet service provider ASP, a service channel 8 is now established between the vehicle 2 and the server 7 external to the vehicle via a first access point APN1, which is also referred to by the English term Access Point Name. This service channel 8, which is based on the general agreement 4 and thus on a contract between the vehicle manufacturer OEM and the Internet service provider ASP, ensures an Internet connection for various telematics services of the vehicle 2. These may include, for example, support for surroundings recognition by calculating the sensor data of the vehicle 2 in the server 7 external to the vehicle, for example image recognition or similar carried out or at least partially carried out in this server 7. The exchange of driving data, navigation data, the installation of updates of the vehicle software or similar can also be carried out via this service channel 8. Normally, this service channel 8 is strictly separated from other Internet connections such that, on the one hand, a relatively high degree of security is guaranteed, since access can typically only be carried out between the server 7 external to the vehicle on the one hand and the vehicle 2 on the other hand, since access is carried out in an encrypted manner and since any other use of the service channel 8 via the first access point APN1 provided for it is not permitted.

For the vehicle user 1 depicted in FIG. 1, an additional Internet connection via a further channel labelled 9 in the depiction of FIG. 2 may now be desirable. Using this, the vehicle user 1 can stream video data or music data, for example, carry out research on the Internet, do online shopping, or similar. For security reasons alone, the data volumes generated for such services should not be processed via the service channel 8. For this reason, the vehicle user 1 can establish an independent connection 10 with the Internet service provider ASP or also an alternative Internet service provider, as can be seen in turn in the schematic depiction of FIG. 1. In practice, however, it is relatively laborious to re-establish such a connection 10 in the vehicle 2, such that a decisive advantage arises for the vehicle user 1 when they can establish such a connection between themselves and the Internet service provider ASP simply and efficiently in their vehicle 2, i.e., via its control system 5 or its head unit 6 as the display and operating part of the control system 5. Instead of the connection 10 depicted dashed in FIG. 1, the vehicle user 1 can achieve a decisive gain in comfort when they can establish the connection to the Internet service provider ASP via the vehicle 2. Such a connection to the vehicle 2 or its control system 5 as an intermediary is depicted by the connection 11 shown as a dotted line.

In this way, a separate further channel 9, as depicted in FIG. 2, can be set up easily and efficiently for the vehicle user 1, which is managed separately from the service channel 8 via a separate access point APN2 of the control system 5 of the vehicle 2. In the depiction of FIG. 2, the Internet 12, which is generally used by vehicle users for private purposes or purposes independent of the vehicle service, is separated and formed independently of the server 7 external to the vehicle. Correspondingly, it is also shown below this as cloud 12. In practice, both networks/servers 12, 7 are here connected to the vehicle 2 via one and the same Internet. The separation of the two clouds 7, 12 in the depiction of FIG. 2 is merely intended to emphasize the usually strict separation of the data streams via the service channel 8 on the one hand and via the further channel 9 on the other hand.

The process for the vehicle user 1 is now substantially as follows:
The vehicle user 1 is in their vehicle 2 and is offered, for example, a media package from the vehicle manufacturer OEM or in the application managed by them on the control system 5 or head unit 6 via the head unit 6 of the control system 5. In order to accept this entertainment package, the vehicle user 1 must correspondingly register and set up their own Internet connection to the Internet service provider ASP. The vehicle user 1 can be informed about this option via the head unit 6, for example, so the vehicle user 1 is offered the opportunity to set up a connection for the further channel 9. When the vehicle user 1 wishes to accept this, they can simply agree to this on the head unit 6 or by voice command. The control system 5, which is at least partially implemented in the vehicle 2 and is symbolized there by the block labelled with 5, can now collect all the data of the vehicle user 1 that is accessible to the control system 5. The individual memory of the control system 5 can be analyzed for this purpose, as can data stored on the server 7 external to the vehicle. In particular, data that is known to the control system 5 through the use of other services and/or vehicles of the vehicle manufacturer OEM is also relevant here.

The control system 5 then extracts parameters from this data that are required in order to set up the Internet connection for the further channel 9 via the second access point APN2. These parameters can now be transmitted to the Internet service provider ASP. If necessary, the vehicle user 1 can be prompted via a pop-up menu or similar on the head unit 6 to enter any missing data in order to extract and transmit all the required parameters. Once the parameters have been transmitted, an Internet connection can then be initiated and the connection 11 shown in FIG. 1 is now established between the vehicle user 1 and the Internet service provider ASP, which was established via the vehicle manufacturer OEM. The further channel 9 can now be established and the use of the content of the booked media package via the Internet in the vehicle 2 can now start.

Technically, it is now problematic that, at the time when the media package is offered to the vehicle user 1, the Internet connection via the second access point APN2 and the further channel 9 on which this media package will later be based does not yet exist. The technical solution thus provides that the service line 8 can be used exceptionally for this process of setting up by enabling, via a whitelist, those Internet addresses that are necessary for the processes described until the further channel 9 is set up, such that in this case, in addition to the regular data transmitted only for internal vehicle service purposes, other parameters can also be transmitted exceptionally to selected Internet addresses via the service channel 8.

The server 7 external to the vehicle is depicted again in the depiction of FIG. 3. For example, it can be a cloud system of the vehicle manufacturer OEM, for example an intelligent cloud system in which data is provided via Kubernetes. Various services can here be implemented in the system. A service area 13, which can comprise a database 14 and various microservices 15.1, 15.2-15.n, can thus be recognized in the center of the depiction of FIG. 3. The service module 13 is connected to the Internet service provider ASP via a programming interface API (Application Programming Interface). In addition to the microservices 15.1, 15.2-15.n depicted in the service module 13, further services are connected to the server 7 external to the vehicle via programming interfaces API and are labelled 16.1, 16.2-16.n here purely by way of example. These services can, for example, be services individually booked by the vehicle user, e.g., navigation services, maintenance flat rates or similar. Moreover, the server 7 external to the vehicle or its service module 13 is now connected to the vehicle 2, in particular to its control system 5 or the corresponding head unit 6. The connection shown in FIG. 3 here represents both the service channel 8 and the other channel 9 in one.

Here, parts of the server 7 external to the vehicle can also take over tasks of the control system 5, thus representing a part of the control system 5, which in this preferred case is implemented as a hybrid control system 5 in parts both in the vehicle 2 and on the server 7 external to the vehicle.

The service module 13 or the control system 5, in particular with its part outsourced in the server 7 external to the vehicle, now communicates via the programming interface API with other already existing services of the vehicle manufacturer OEM, which are summarized here as the services 16.1, 16.2-16.n. This allows relevant data to be collected for setting up the further channel 9 of the vehicle user 1 with the Internet service provider ASP. This allows relevant data to be collected for setting up the additional channel 9 of vehicle user 1 with the Internet service provider ASP. Some of the necessary parameters are then extracted from this and combined with further parameters of the control system 5, which can be based e.g., on technical variables such as the required data volume, etc., and passed on to the Internet service provider ASP via the programming interface API. The control system 5 with the head unit 6 can then request authorization to transmit the parameters to the Internet service provider ASP for the further channel 9 in the region of the vehicle 2. Instead of the head unit 6, any other component connected to the Internet can also be used, for example a browser on any computer, a mobile application on a smartphone, tablet or similar.

On the network side, for example, the first access point APN1 is set up for the vehicle 2 via the vehicle manufacturer OEM and the Internet service provider ASP in order to exchange data via the service channel 8 established via it. The vehicle 2 can use the Internet connection via the service channel 8, for example, to download software updates, support telematics systems, for example by at least partially outsourcing image recognition to the server 7 external to the vehicle when using a surroundings sensor system, or similar. When the vehicle user 1 now wishes to use their own services, such as video streaming, music streaming or similar, for example, the vehicle user 1 should have a connection 10, 11 set up for themselves with the Internet service provider ASP. To this end, the vehicle manufacturer OEM wants to offer the vehicle user 1 a service that is as comfortable as possible, such that the vehicle 2 or the control system 5 acts as a kind of intermediary and offers the vehicle user 1 a connection 11 to the Internet service provider ASP with regard to a second access point APN2 for setting up the further channel 9. However, at the point in time at which this connection 11 is to be established, there is no Internet connection between the vehicle 2 and the Internet service provider ASP that can be used by the vehicle user 1 as the end customer. Therefore, the control system 5 now enables the use of service channel 8 as an exception, especially for this case. This can be achieved, for example, by storing the Internet pages required for this in a whitelist of the control system 5, such that despite the otherwise strict separation between service data and further data, the service channel 8 can be used in this case to set up the further channel 9 via the second access point. The IP addresses of this whitelist can, for example, be stored in the head unit 6 or also in the region of the server 7 external to the vehicle.

Here, the construction requires a single SIM, which can be implemented as a SIM card or eSIM, for example. The first access point APN1 and the second access point APN2 are thus implemented via one and the same Internet service provider ASP, which can be advantageous in that the Internet service provider ASP with the general contract with the respective vehicle manufacturer OEM also benefits from the end customer business, which the vehicle manufacturer OEM correspondingly mediates, and can offer preferred prices for the customers of the respective vehicle manufacturer OEM due to the expected higher volume of such end customer contracts.

FIG. 4 now shows the substantial steps that are implemented for carrying out the method:
In the first depicted step, the activation request for the further channel 9 is received. For example, the vehicle user enters in the head unit 6 of the vehicle 2 that they want a specific media package, for example an annual flat rate, a monthly flat rate, a theme-related flat rate, a certain amount of data or similar.

In the next step, vehicle data and vehicle user data are received from all sources accessible to the control system 5 internally or on the server 7 external to the vehicle in order to thus provide all parameters required for setting up the new Internet connection directly from this data, if possible. In particular, these parameters can comprise the user identification, a vehicle identification and further parameters, which can comprise technical variables for setting up the Internet connection or are derived from them. These may include, for example, the data volume, the security settings and similar.

These parameters can then be transmitted via the service channel 8 to the Internet service provider ASP, which then prepares to set up the connection 11. This step can be implemented both with the Internet service provider and via the control system 5, in particular in its part that co-operates with the service module 13. In the exemplary embodiment depicted in FIG. 4, this preparation is preferably carried out by the Internet service provider ASP.

The control system 5 then receives a URL of the Internet service provider ASP via the service channel, which summarizes the preparations for the connection 11. This is displayed to the vehicle user 1 on the head unit 6, for example, such that they can complete any possibly missing data and, in particular, start setting up the further channel 9 by means of suitable authentication and acknowledgement.

Subsequently, after the setup, the further channel 9 is then enabled.

Finally, the status of the further channel 9 can now be set to connected in order to then strictly separate the data transfer between the further channel 9 on the one hand and the service channel 8 on the other hand, such that the service channel 8 is really used exclusively for the service-relevant data transfer and may only be misused here in exceptional cases to set up the further channel 9 between the vehicle user 1 and the Internet service provider ASP, so to speak.

In addition, the country of vehicle registration can also be queried in the vehicle data to extract the parameters, in order to offer, for example, the connection to the Internet service provider in the corresponding language and/or with the appropriate legal framework for the respective country.

The whole process is particularly efficient and comfortable for the vehicle user 1 when the authentication for the connection 11 can be carried out simply and efficiently with the aid of an authentication already carried out in the vehicle 2. This is referred to as single sign-on. For example, hardware authentication of the vehicle user 1 in comparison to the vehicle 2 can be used for this purpose, for example a corresponding code that is stored in a mobile device, a key, a smartphone, a smartwatch, a smart ring or similar and authenticates the vehicle user 1 in comparison to the vehicle 2, e.g. as part of a check of access and/or driving authorization.

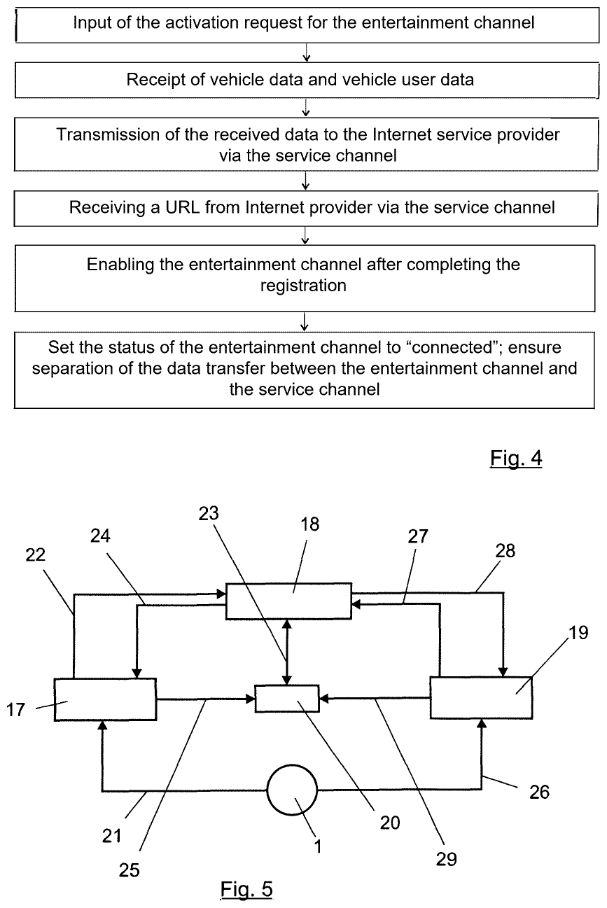

A single sign-on can also be implemented, for example, according to the depiction in FIG. 5. Here, the vehicle user 1 is depicted as a circle at the bottom as an example. On the left is a domain of the vehicle manufacturer OEM labelled with 17, at the top center is an authentication server labelled with 18 and on the far right is the domain of the Internet service provider ASP labelled with 19. In between is a cookie memory 20, which can be part of a browser used in the head unit 6 or another type of device, for example. The process would now be such that the vehicle user 1 first browses to the domain 19 of the vehicle manufacturer OEM. From the domain 17 of the vehicle manufacturer OEM, the user is then forwarded according to the arrow 22 to the authentication server 18, in which a login of the vehicle user 1 or a cookie is available and authenticated. This is correspondingly stored in the cookie memory 20, which is indicated here by the arrow 23. A token is then sent to the domain 17 of the vehicle manufacturer according to the arrow 24, where the token is used in order to authenticate the vehicle user 1. The arrow 25 then indicates that a further cookie is stored in the cookie memory 20 based on this authentication. In the next step, the vehicle user 1 browses to the domain 19 of the Internet service provider ASP according to the arrow 26, wherein the same process is repeated here. This in turn begins with the forwarding according to the arrow 27 to the authentication server 18, the storage of the corresponding cookie according to the arrow 23 in the cookie memory 20 and the sending back of a token according to the arrow 28 to the domain 19 of the Internet service provider ASP. Here, too, authentication is carried out using the token with the storage of a cookie according to the arrow 29, such that authentication is hereby connected.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-12. (canceled)

13. A method comprising:
setting up, by a control system of a vehicle with a first access point, a connection for a service channel between a vehicle manufacturer and an Internet service provider, wherein the control system is configured to maintain at least two access points, wherein the at least two access points include the first access point and a second access point, and wherein the second access point provides a further channel;
collecting, by the control system prior to using the further channel, user-related data, wherein the user-related data is known to the control system or is accessible, via the service channel, to the control system on a server external to the vehicle of the vehicle manufacturer; and
extracting, after collecting the user-related data and from the collected user-related data, parameters required for establishing an Internet connection via the further channel;
transmitting, by the control system, the extracted parameters to the Internet service provider; and
transmitting, by the control system, via the first access point.

14. The method of claim 13, wherein the extracted parameters comprise at least user identification data for setting up the second access point.

15. The method of claim 13, wherein the extracted parameters comprise at least one technical variable for setting up the second access point.

16. The method of claim 15, wherein the control system predicts an amount of data required for the further channel and uses the predicted amount of data as the technical variable.

17. The method of claim 13, wherein the extracted parameters comprise a country of a vehicle registration.

18. The method of claim 13, wherein at least one of the extracted parameters is determined by analysis of previous user behavior, present boundary conditions, or preinstalled applications.

19. The method of claim 13, wherein after user authentication has been performed, the control system generates a parameter suitable for authentication.

20. The method of claim 13, wherein data required for creating the parameters, which is not known to the control system or is not accessible to the control system, are requested from a vehicle user.

21. The method of claim 13, wherein in order to allow the extracted parameters to be transmitted via the first access point, access data to a required Internet addresses is allowed via an exception list.

22. The method of claim 13, wherein the control system strictly separates data transfer via the service channel and data transfer via the further channel after completion of a setup of the second access point.

23. The method of claim 13, wherein the control system is implemented at least partially on the server external to the vehicle.

24. The method of claim 13, wherein the control system is implemented at least partially in a computing unit of the vehicle.
